(19) United States
(12) Patent Application Publication
(10) Pub. No.: US 2001/0044365 A1
(43) Pub. Date: Nov. 22, 2001

(54) Shaped Casing for a food product, and method and apparatus for making same

(76) Inventor: Albert Beuttenmueller, Stelle (DE)

Correspondence Address: PATENT DOCKET CLERK, JENNER & BLOCK, ONE IBM PLAZA, CHICAGO, IL, 60611, US

(21) Appl. No.: 09/859,156

(22) Filed: May 17, 2001

(30) Foreign Application Priority Data
May 17, 2000 (DE) DE - 100 24 639.7

(51) Int. Cl. B31C 11/04

(52) U.S. Cl. 493/276

(57) ABSTRACT

Shaped element having irregular external contours and adapted to be made from a two-layered quasi-endless web comprising two layers of a weldable plastics film material in a station simultaneously welding and severing said layers. Once severed and welded, the shaped element comprises a casing (53) consisting of a multilayered film (58-58n) and intended for a food product; the casing may be provided with a strippable outer film (57) for protection when handled.

The invention relates to a shaped element having irregular external contours and adapted to be made from a quasiendless web consisting of two layers of a weldable plastics film material in an apparatus simultaneously s welding and severing said material layers; it also relates to a method and apparatus for making such element.

Shaped elements of this kind—such as sausage casings as known by DE 39 02 347 A1for curved or curled to sausages shaped like natural gut—usually are sewn along their longitudinal seams. To this end, these sausage casings are sewn when turned inside out, then turned back out and filled with sausage meat. In the process, there is the problem that filling the casing 15 causes a build-up of pressure which acts to expand the stitch holes of the seams, where sausage meat will leak out; this may result in a 2 to 5% cooking loss.

The object of the present invention is to provide sausage casings in the shape of natural gut that are leak-proof, are suited for smoking and have adequate strength.

This object is achieved by the severed and welded shaped element being a casing for a food product and consisting of a multi-layered film material.

The invention seeks also to provide apparatus for practicing the aforesaid method.

This object is achieved by apparatus for producing a simultaneously severed and welded casing for a food product, said casing having irregular external contours and consisting of a multi-layered film comprising top and bottom layers of a quasi-endless web of a weldable plastic film material, wherein said web of film material is placed in a severing and welding station having therein a weld contour wire laid in the shape of the external contours of the casing and adapted to have welding energy applied thereto, said web of film material adapted to be placed on a platen and to be pressed thereonto over the weld contour wire by means of a pressure plate.

These measures provide apparatus for making sausage casings of film material which have nature-like external contours. Suitable film materials are single-or multi-layered polyethyl films. The sausage casings consist of films approx. 10 to 50 micrometers thick and welded together along their external contours. They have a sufficient mechanical strength without any risk to burst or to be excessively stretched as sausage meat is introduced into them under pressure. A sausage casing so made allows the intended amount of sausage meat to be filled in without excessively extending the casing.

In order to impart to the finished sausages an appearance answering the consumers' expectations, it is contemplated to print decorative images on the film material web to be processed or to provide the welded casing with an envelope of a textile material. To this end, the textile envelope may be adhesively bonded to the welded casing and may have an image printed thereon.

Further advantageous measures are described in the dependent claims. The invention is shown in the attached drawings and is described in greater detail below.

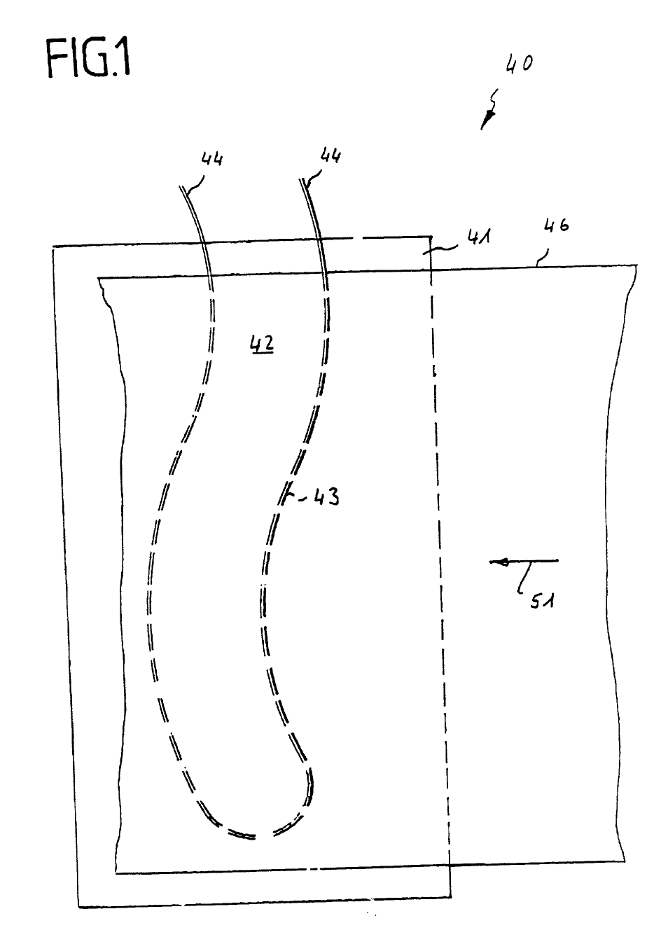

FIG. 1 is a view in plan showing the platen of apparatus for making a shaped element having external contours in any shape, such as a sausage casing, said apparatus comprising a freely laid-out weld contour wire placed thereon for welding and severing the shaped element;

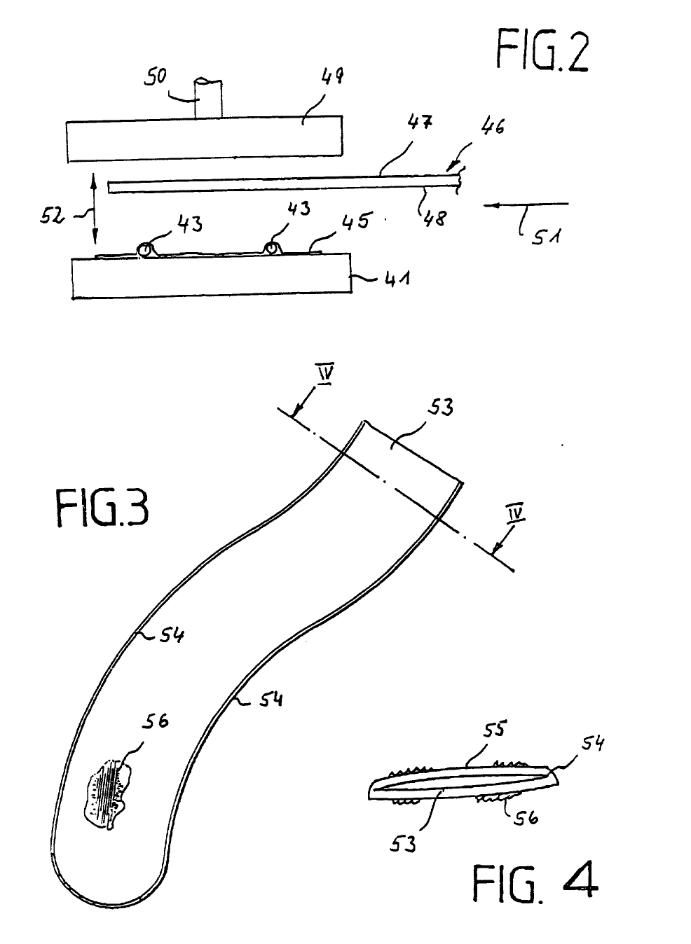

FIG. 2 shows a schematic front view of apparatus as in claim 1 with the weld contour wire placed on a platen, a pressure plate, and a quasi endless web of film material advanced between the weld contour wire and the pressure plate for processing;

FIG. 3 schematically shows a finished welded casing severed from the endless web of film material;

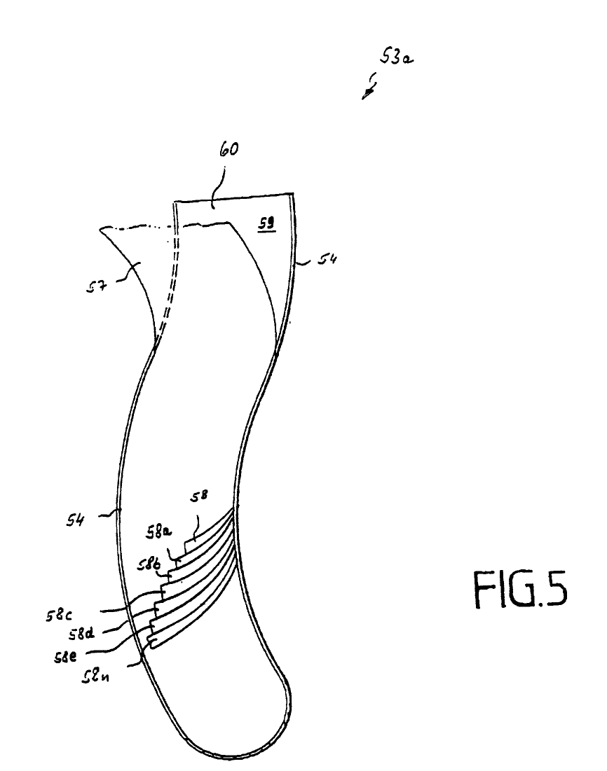

FIG. 4 is a view in section through a casing along line IV-IV in FIG. 3 and shows an additional textile envelope printed with a decorative image;

FIG. 5 schematically shows a finished welded casing severed from the endless web of film material, said casing consisting of a plurality of bonded-together film layers stacked on top of each other and encased with a non-bonded strippable protective film; and

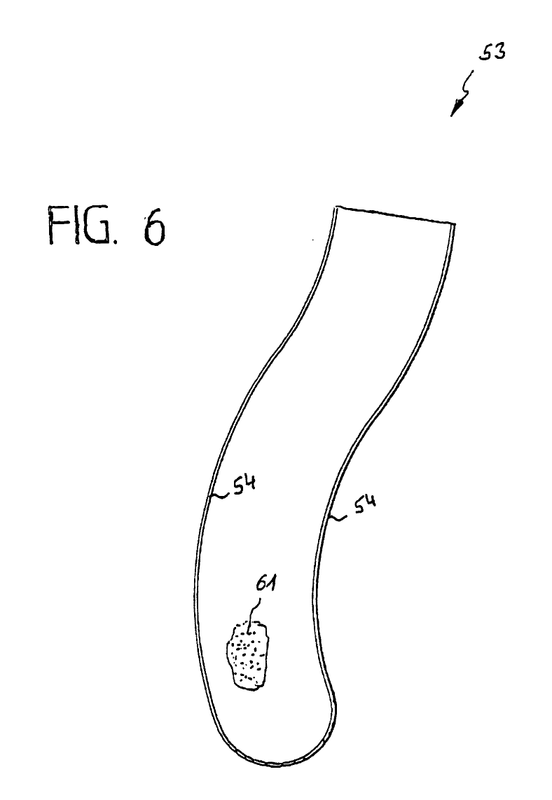

FIG. 6 schematically shows a micro-perforated finished welded casing separated from the endless web of film material.

The severing and welding apparatus 40 schematically shown in FIGS. 1 and 2 essentially comprises a platen having placed and fixed thereon a weld contour wire 43 laid out in a shape conforming with the external contours 42 of a casing 53 to be made. Platen 41 consists of a plastics material, preferably polyester. Weld contour wire 43 has electric terminals 44 projecting beyond the periphery of platen 41.

As shown in FIG. 2, weld contour wire 43 is fixed in place on platen 41 by means of a film cover 45. A suitable material for such cover film is a high-temperature-resistant plastic film. A single platen 41 can have fixed thereonto weld contour wires 43 for a plurality of casings 53 having external contours 42 which may be equal or different.

For making a shaped element, such as a sausage casing 53 as shown in FIG. 3, a quasi-endless web of film material 46 to be processed, such as a plastics film, is placed over weld contour wire 43. For example, web of film material 46 may consist of a plastic film material permeable to smoking gases. The film material thickness is variable and may amount to approximately 10 micrometers to approximately 50 micrometers.

The film material web 46 to be processed is laid out to have two layers, i.e. a top layer 47 and a bottom layer 48, which are adapted to be withdrawn quasi-endlessly from a coil (not shown).

With film material web 46—such as a weldable plastic film of variable thickness—in place, a pressure plate 49 may be moved downwards against platen 41 in a closing direction 52 (dual arrows) by lowering mechanism 50.

The downward pressure exerted by pressure plate 49 is variable and can be controlled to harmonize with the weld energy—e.g. electric energy—introduced into weld contour wire 43 at electric terminals 44.

The weld energy in weld contour wire 43, which is adjusted to the downward pressure exerted by pressure plate 49, act to weld top layer 47 to bottom layer 48 of the web of film material 46 to be processed. At the same time, the casing 53 so welded is severed from the remaining web of film material 46.

Alternatively, a computer-controlled laser (not shown) can be moved across the two-layer web of film material 46 to sever a preprogrammed casing shape therefrom and at the same time cause layers 47, 48 to be welded to each other.

With pressure plate 49 lifted out of the way, film material web 46 can now be advanced in its direction of movement 52 (arrow), whereafter the welding and severing of the next casing 53 may commence. After casings 53 have been removed from web 46, the residual grid of web material may be recycled.

As shown in FIG. 3, the external contours of the finished severed and welded casing 53 are formed by a peripheral weld 54. Weld 54 corresponds to the shape of weld contour wire 43 and may have any shape before weld contour wire 43 is shaped to conform therewith and fixed in place by means of the film cover. At the time top and bottom layers 47, 48 are welded to each other, the finished casing 53 is separated from the processed web of film material 46.

As shown in FIG. 4, the finished casing 53—such as a sausage casing—may additionally be provided with a textile casing 55. A decorative image 56 may be printed on textile casing 55. Such decoration 56 may be printed directly on web of film material 46 to be raised therefrom, as shown in FIG. 3.

Textile casing 55 may be adhesively bonded to finished casing 53 so as to facilitate the stripping thereof for processing or consumption. A food product—such as a sausage—enveloped with a casing 53 of the aforesaid kind is sterile and is suited for smoking.

The casing 53a shown in FIG. 5 consists of a composite film 60 built up of a plurality of film layers 58-58n. Film layers 58-58n are superimposed onto each other individually and bonded to each other to form an integral structure.

Casing surface 59 of outermost film layer 58n has a film 57 placed thereabout for protection when handled. Protective film 57 is not bonded to film layer 58n and strips readily from casing surface 59. Protective film 57 is simultaneously welded to and severed from a quasi-endless web of film material together with casing 53a. To this end, an additional layer consisting of the material of protective film 57 is used to envelope film layers 58-58n. In so doing, protective film layer 57 is not bonded to casing surface 59 of outermost film layer 58n.

In case the sausage in question is raw sausage, it is contemplated in further embodiments to provide casing 53 or 53a with micro-perforations 61, as shown in FIG. 6, so as to allow a loss of water to take place for curing.

To this end, casing surface 59 may be micro-perforated or pin-holed by means of a laser beam or the like so as to permit water vapor to escape from the sausage meat as it is curing. Once cured, a sausage so perforated may be provided with a dip-coated protective film to inhibit additional water loss.

Whereas the present invention has been described with respect to specific embodiments thereof, it will be understood that various changes and modifications will be suggested to one of ordinary skill in the art, and it is intended that the invention encompass such changes and modifications as fall within the scope of the appended claims.

What is claimed is:

1. A shaped element for a food casing comprising:
a first layer (47) of a web of film material (46) and
a second layer (48) of a web of filmmaterial (46),
wherein said first layer (47) and said second layer (48) are severed from said web of film material (46) and welded together to form the shaped element for a food casing (53).

2. A shaped element as in claim 1, wherein said web of film material (46) comprises a multi-layered film (58-58n).

3. A shaped element as in claim 1 further comprising a strippable protective film (57) covering said food casing (53).

4. A shaped element as in claim 3 wherein said strippable protective film (57) is severed and welded to said multi-layered film (58-58n) in the desired shape without being bonded to the outermost layer (58n) of said food casing (53).

5. A shaped element as in claim 1, wherein said multi-layered film (58-58n) is provided with micro-perforations (61) permeable to water vapor.

6. A shaped element as in claim 1, wherein the outermost layer of the multi-layered film (58-58n) has a decoration (56) thereon.

7. A shaped element as in claim 1, wherein the outermost layer of the multi-layered film (58-58n) has a raised decoration (56) thereon.

8. A shaped element as in claim 1, wherein said food casing (53) is provided with a textile envelope (55).

9. A shaped element as in claim 8, wherein said textile envelope (55) is adapted to be brought in a cooperative relationship with said food casing (53).

10. A shaped element as in claim 9 wherein said textile envelope (55) has a decoration (56) thereon.

11. An apparatus for fabricating a casing for food products comprising:
a platen (41),
a weld-contour wire (43) on the top surface of said platen (41),
and a pressure plate (49),
wherein said pressure plate (49) is adapted to be pressed down onto said weld contour wire (43) to sever and weld a multi-layered plastic film(58-58n) into a casing (53) for food products.

12. An apparatus for fabricating a casing for food products as in claim 11, wherein the severing and welding is performed simultaneously.

13. An apparatus for fabricating a casing for food products as in claim 11, wherein the weld contour wire (43) is an irregular shape.

14. An apparatus for fabricating a casing for food products as in claim 11, wherein said weld contour line (43) has a closed external outline and a film cover (45) laid thereover on said platen (41).

15. An apparatus for fabricating a casing for food products as in claim 11, wherein said platen (41) comprises a planar platen.

16. An apparatus for fabricating a casing for food products as in claim 11, wherein said weld contour line (43) has electric terminals (44).

17. An apparatus for fabricating a casing for food products as in claim 16, wherein said electrical terminals (44) extend away from said platen (41).

18. An apparatus for fabricating a casing for food products as in claim 16, wherein said weld contour line (43) is adapted to have sufficient electrical energy to weld plastics applied at said electrical terminals (44).

19. An apparatus for fabricating a casing for food products as in claim 16, wherein said weld contour line (43) is adapted to have plastics welding energy of varying intensity applied at said electrical terminals (44).

20. An apparatus for fabricating a casing for food products as in claim 11, wherein said platen (41) has thereon a plurality of weld contour wires (43) forming separate casing contours.

21. An apparatus for fabricating a casing for food products as in claim 11, wherein said pressure plate (49) is operable at variable pressures onto said weld contour wires (43).

22. A method of making a shaped plastics element having irregular contours comprising the steps of:
placing a two layered quasi-endless web consisting of a weldable plastics material in a welding and severing station,
severing a shaped element from said web, and
simultaneously welding said shaped element to be used as a casing for a food product.

23. A method of making a shaped casing for a food product having irregular external contours comprising the steps of:
placing a two layered quasi-endless web consisting of a weldable plastics material in a welding and severing station,
moving a computer-controlled laser over said two layer plastics material web to sever a preprogrammed casing shape from said web and
simultaneously welding the top and bottom layers of said film material to each other.
